(19) United States
(12) Patent Application Publication
(10) Pub. No.: US 2021/0019436 A1
(43) Pub. Date: Jan. 21, 2021

(54) COMMUNICATING CONTENT OVER A COMMUNICATIONS NETWORK

(71) Applicant: Medox Exchange, Inc., New York, NY (US)

(72) Inventor: Michael Beck, New York, NY (US)

(21) Appl. No.: 16/515,800

(22) Filed: Jul. 18, 2019

(51) Int. Cl. G06F 21/62; H04L 29/06; G06F 21/60; H04L 9/08

(52) U.S. Cl. CPC G06F 21/6218; H04L 63/105; H04L 9/0819; H04L 63/08; G06F 21/602

(57) ABSTRACT

Systems may provide a client access and use of secure data with authorization from a server. In the systems there may be a number of relevant party roles, and a user may have one or more of the roles. The roles may be implicitly or explicitly assigned. Related apparatus, systems, articles, and techniques are also described.

### BACKGROUND

A communications network is a collection of terminal nodes in which links are connected so as to enable communication between the terminals. Transmission links connect the nodes together. The nodes use circuit switching, message switching or packet switching to pass the signal through the correct links and nodes to reach the correct destination terminal. Each terminal in the network usually has a unique address so messages or connections can be routed to the correct recipients. The collection of addresses in the network is called the address space. Examples of communications networks include computer networks, the Internet, the telephone network, and the global Telex network.

### SUMMARY

In general, systems may provide a client access and use of secure data with authorization from a server. In the systems there may be a number of relevant party roles, and a user may have one or more of the roles. The roles may be implicitly or explicitly assigned. For example, a doctor requesting information about a patient may be implicitly assigned a role as a data content recipient. The roles may include: data content subject, a role describing a party about whom data is being shared (e.g. in a health information environment, it may be a patient); data content recipient, a role describing a party who is seeking access to information regarding one or more data content subjects; data custodian, a role describing an owner of a source of information regarding a data content subject (e.g., in a health information environment, a doctor's office, hospital, or insurance company may have this role), which may be required by regulation or responsibility to log or control access to that information; data publisher, a role describing an aggregator of information regarding one or more data content subjects, who may additionally be a data publisher; relationship administrator, a role describing someone who represents a governing entity responsible for maintaining, or creating data content subject, data content recipient, and data custodian accounts (e.g., in a health information environment, an employer's group benefit's administrator or an insurance company's product contract group); and, a role describing a system administrator, who at a more supreme level may manage relationships (e.g., relationships between data subjects and data content recipients) and accounts (e.g., information about a data content subject or data custodian) in the systems. In some implementations a program may be a user that has one or more roles. For example, a program may be a data content recipient and may request data.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a diagram of a system to provide dynamic binding of access and usage rights to computer-based resources.

FIG. 2 is a diagram of a system to provide generation of secure content, and dynamic binding of access and usage rights with a credential server.

FIG. 3 is a diagram of a structure for a secure document.

FIG. 4 is a flowchart illustrating a process of dynamic binding of access and usage rights.

Like reference numbers and designations in the various drawings indicate like elements.

### DETAILED DESCRIPTION

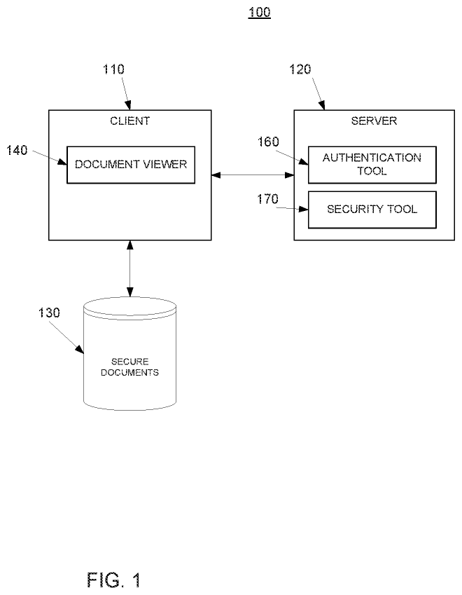

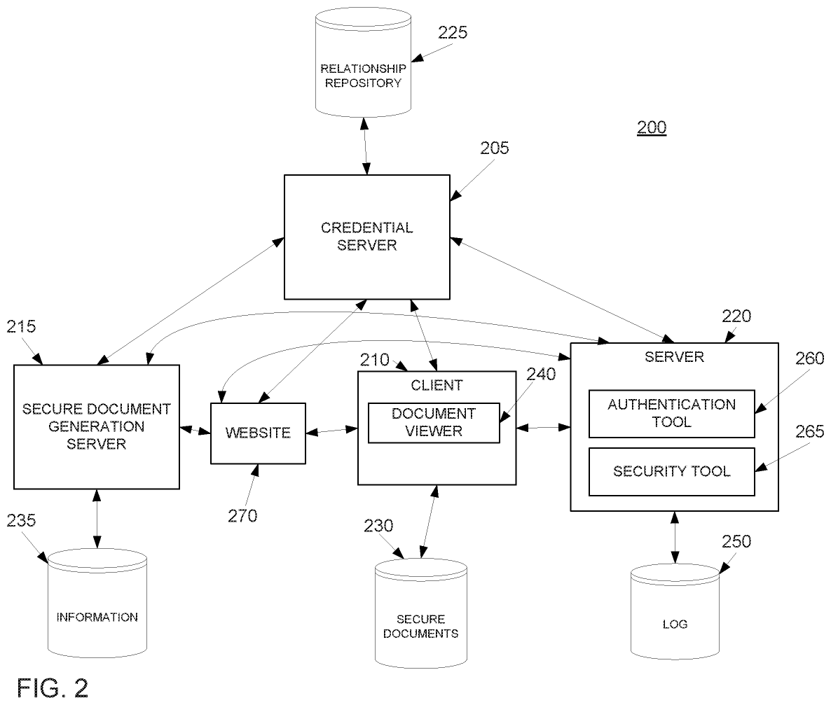

In general, the systems 100, 200 of FIGS. 1, 2 may provide a client access and use of secure data with authorization from a server. In the systems 100, 200, there may be a number of relevant party roles, and a user may have one or more of the roles. The roles may be implicitly or explicitly assigned. For example, a doctor requesting information about a patient may be implicitly assigned a role as a data content recipient. The roles may include: data content subject, a role describing a party about whom data is being shared (e.g. in a health information environment, it may be a patient); data content recipient, a role describing a party who is seeking access to information regarding one or more data content subjects (the data may be packaged in a ‘secure container’ or ‘secure container holding’ as will be described later); data custodian, a role describing an owner of a source of information regarding a data content subject (e.g., in a health information environment, a doctor's office, hospital, or insurance company may have this role), which may be required by regulation or responsibility to log or control access to that information; data publisher, a role describing an aggregator of information regarding one or more data content subjects, who may additionally be a data publisher; relationship administrator, a role describing someone who represents a governing entity responsible for maintaining, or creating data content subject, data content recipient, and data custodian accounts (e.g., in a health information environment, an employer's group benefit's administrator or an insurance company's product contract group); and, a role describing a system administrator, who at a more supreme level may manage relationships (e.g., relationships between data subjects and data content recipients) and accounts (e.g., information about a data content subject or data custodian) in the systems 100, 200. In some implementations a program may be a user that has one or more roles. For example, a program may be a data content recipient and may request data in either of the systems 100, 200 of FIGS. 1 and 2.

In some implementations party roles may have variances. For example, there may be a distinction between a data content owner and data content custodian. For example, a data content subject may be a data content owner, and a data content custodian may have care over content or information of the data content owner. For example, in one system an insured party may be a data content subject and data content owner, where an insurance company of the insured party is the data content owner; however, in another system, an insured party may be a data content subject but not a data content owner, and, an insurance party may be the data content owner and data content custodian.

FIG. 1 is a diagram of a system 100 to provide dynamic binding of access and usage rights. The system 100 includes a client 110, a server 120, and a repository 130 of secure documents. In general, the client 110 may request access to components of secure documents in the repository 130 by requesting access from the server 120. Then, the server 120 may authenticate the user and authorize access, use, or both at the client 110. Authorizing access or use may include sending to the client 110 a version of a component of a secure document having first type of security removed in lieu of a second type of security that can be removed by the client 110.

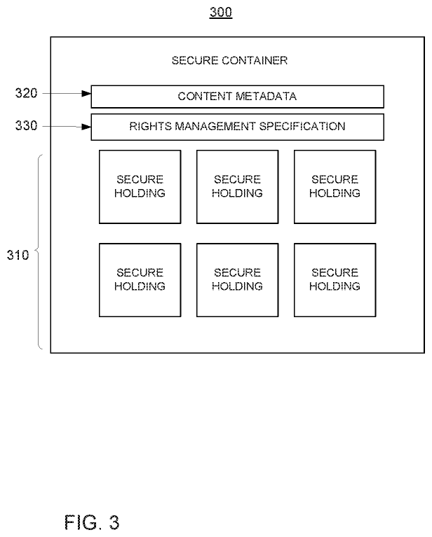

In general, a secure document may be a secure container for computer-based resources, or content, such as a secure container structure 300 of FIG. 3 and each of the components of a secure document may be one of secure holdings 310, which contain computer-based resources. Components of the secure documents at the repository 130 may be electronic documents or references to resources, such as electronic documents. For example, components of secure documents may include such computer-based resources, or content, such as audio, image, binary, and text files; these types of content and other computer-based resources, either singularly or in the aggregate collectively also referred to as computer files or documents. As another example, a reference to a computer-based resource, such as a uniform resource indicator (URI), may be encrypted in a component of the secure document, the component may be decrypted, and the uniform resource indicator may be used to download and access the computer-based resource referred to by the uniform resource indicator.

The repository 130 may be shared among a number of potential recipients (e.g., a file server, and the like), shared between a number of potential recipients and data content subjects (e.g., a mobile phone, personal digital assistant, UNIVERSAL SERIAL BUS drive, and the like), or represent the attachment of the secure format to another secure or insecure format (e.g., as an email attachment, a multimedia mobile message service communication, network message, peer-to-peer computing communication, and the like).

As an example of operation of the system 100, electronic medical records of a data subject may be stored in an encrypted format at the repository 130 of a data recipient. The data recipient may request access from the server 120 to view a medical record through the client 110 by sending credentials, the medical record, and description of the action desired to be performed at the client 110 to the server 120. Based on the credentials authenticating the client 110 and authorization of usage of the record, the server 120 may decrypt the record and re-encrypt the record in accordance with a session key negotiated with the client 110. The record, encrypted with the session key, may be sent back to the client 110 by the server 120. Then, the client 110 may allow usage of the record in accordance with the requested action. Access and usage of the record may be in accordance with terms and conditions specified in the secure document, or the component of the secure document. In some implementations, components of a secure document, rather than an entire secure document, may be requested for access, sent to the server 120, and decrypted.

The client 110 may allow for access and usage of components of secure documents of the repository 130. The types of access and usage may include viewing, copying (e.g., copying and pasting of text, screen captures, and the like), modifying, printing, exporting (e.g., exported from a security container or the client 110), and the like.

The client 110 includes a document viewer 140. The document viewer 140 may present documents to a user for which the client 110 has access and usage rights and allow for types of access and usage other than viewing to be performed depending on access and usage rights granted to the client 110. For example, a user of the client 110 may be prevented from any type of access, in which case, a document might not be viewable. As another example, a user of the client 110 may be allowed to view and print documents, but, might not be allowed to copy or modify documents.

The document viewer 140 may accept plug-ins. For example, a trusted extension may be a plug-in and the trusted extension may allow specific types of components of documents to be viewed. As another example, a plug-in may perform optical character recognition of image files in the document viewer 140.

To ensure enforcement of access and usage rights, the client 110 may be required to be a trusted client. For example, the client 110 may be authenticated by the server 120 as a client that ensures enforcement. For example, the client 110 may send authentication information to the server 120 to indicate the client 110 is a proper client for authorizing access or use of secure documents. For example, the client 110 may be proprietary to ensure enforcement of security (and, prevention of unauthorized access) or may be certified as following a specification for clients (or, client environments). For example, the client 110 may be a tool in a suite of software tools that make up an application and the tool may be certified as a client complying with a specification for security enforcement. As another example, the client 110 may be a suite of software tools or programming interfaces that ensure enforcement of access and usage rights.

The client 110 may request access and usage rights from the server 120 by, as examples, establishing a secure server session, sending an application to application message, and the like. The request may include different types of information. For example, a request may include metadata for a document and a secure version of the document. In addition to metadata, other information may include, as example, a version of a client or the component of the secure document, key specifications (e.g., a reference or description of a key used for the component), or cryptography algorithms enforced or required for document security and access/use.

Advantageously, including a document as part of a request may allow for distributed storage of documents and may facilitate transport of documents, as the server 120 need not store secure documents and users need not contact the server 120 to receive documents (e.g., secure, encrypted documents may be transferred or accessed via electronic mail, a UNIVERSAL SERIAL BUS-compliant memory key, mobile phone, personal digital assistant, and the like). In addition, the document may be signed (e.g., cryptographically signed) such that the client 110 or server 120 may authenticate the document (e.g., to indicate a document has not been altered). In some implementations, to reduce network bandwidth consumption or unnecessary storage by data content recipients, secure documents or portions of secure documents may be cached or stored at the server 120 and a request from client 110 may simply identify a secure document or portion of a secure document to be accessed without including that content along with user credentials and proposed action for usage at client 110, such that the secure document or portion of secure document, which may be accessible only to server 120, may have first security removed and second security added, and secure document or portion of secure document with second security is sent back to client 110.

The document viewer 140 of the client 110 may allow for exploring of secure documents or components of secure documents of the repository 130. For example, a user of the client 110 may browse a list of secure documents and may select a secure document to view, which may cause the document viewer 140 to request access for viewing the selected secure document. The repository 130 may be remote (e.g., not proximal) from the client 110 such that secure documents or components of secure document may be accessed by browsing using protocols including FTP (File Transfer Protocol), WebDAV (Web Distributed Authoring And Versioning), HTTP/SHTTP (HyperText Transfer Protocol/ Secure HyperText Transfer Protocol), and the like. The client 110 may be embedded in other application or called by another application as a plug-in or helper to assist with the content type associated with the secure document or component of secure document type used for communication between client 110 and server 120 in a specific computing or operating environment. This association may occur by mechanisms including Internet Engineering Taskforce (IETF) specification compliant MIME (Multipurpose Internet Mail Extensions) type or operating system extension. To allow for management of secure documents before access and usage rights have been granted, some metadata of the secure documents may be viewed. For example, a name of a computer-based resource stored as a component of a secure document or a short description of that component of a secure document might be used and need not be secured from viewing by a user who has not been authenticated.

The server 120 may authorize access and use of secure documents of the repository 130 by authenticating a user with an authentication tool 160 and authorizing the user by removing security of a document with a security tool 170. In addition to removing security, the security tool 170 may be used to apply security to the document. For example, a user may request access to a document by sending a request from the client 110 to the server 120 and the server 120 may authenticate the user of the client 110 with the authentication tool 160. Then, if authenticated and authorized, the security tool 170 may be used to remove the security from a secure document, and, the document may be sent to the client 110 with a different, second security for the document. This second security may be specific to the client 110, the user of client 110, or negotiated as a characteristic of the specific use or request.

In some implementations, the server 120 may move a secure document from a first trusted environment to a second trusted environment by removing a first security and adding a second security. The server 120 may also remove first security and add a second security for reasons other than changing trusted environments, including updating security with a type of security considered more secure, updating security with a type of security of varying strength or algorithm characteristic, or updating security with security supported with credentials that are issued to replace credentials that have expired with regard to previous security (e.g., a different set of credentials to be used to decrypt components of secure documents), or changing security as may be necessitated for distribution of content (e.g., for security supported by another platform).

The first security and the second security may use same or different techniques, mechanism, or a combination of the two. For example, the first security may use a same encryption technique as the second security but may require different credentials. As another example, the secure documents of the repository 130 may be encrypted using a first security technique and the security tool 170 may be used to remove the encryption. Then, the security tool 170 may use a second type of security, such as a secure server session between the client 110 and server 120 to send the secure document or part of the secure document to the client 110. Advantageously, the first security of secure documents might only be removable at the server 120 to enhance security of the secure documents and the computer-based resources they contain (e.g., to avoid having to send a cryptographic private key to the client 110 to decrypt secure documents, which might jeopardize a trusted use of that private key if the key is intercepted or otherwise obtained by an unauthorized party).

In general, secure documents of the repository 130 are secured to prevent access and use of their content. For example, each component of a secure document may be encrypted using an encryption scheme and the client 110 might not have a decryption engine, resources, or necessary credentials to decrypt the documents. To access the content of the documents, as described above, the server 120 may replace security of the documents with a security that can be removed by the client 110 (e.g., as a form of granting access). In some implementations, multiple clients may share a same authentication and security tool of the server 120. For example, multiple clients may request access to a component of a secure document from the server 120 and each client 110 may obtain access to that component using a negotiated second security that is different from the first security, but unique to itself, such that content may be accessed. Separate credentials presented by client 110 to server 120 on behalf of a specific user of client 110 may be used as criteria for which a negotiated second security that allows for access to content of a secure document or component of a secure document to be obtained.

Access and usage rights may have a variety of properties, in addition to there being different types of access and usage rights. For example, access and usage rights may have temporal properties. For example, access and usage rights may be granted for a period of time, for as long as a client is in use, or as long as a negotiated, secure session between the client 110 and server 120 exists. For example, in response to receiving access and usage rights, the document viewer 140 may present content to an authorized user until a secure session with the server 120 ends.

Although the system 100 of FIG. 1 includes a certain combination of features, additional, different, or fewer features may be included. For example, the authentication tool 160 may be a same tool as the security tool 170. As another example, although components of documents, such as secure holdings or components of secure holdings, which are described with reference to FIG. 3, are granted access, access may be granted for entire documents.

The client 110 may have credentials in addition to user credentials by which the server may establish trust of the client (e.g., code signing of the client), such that the server 120 is able to verify that the client 110 adheres to established standards for governing user access and usage to data by the articulated authorization policy granted by the server 120.

FIG. 2 is a block diagram of a system 200 to provide generation of secure content (e.g., documents or components of documents), and dynamic binding of access and usage rights with a credential server 205. The system 200 includes many features of the system 100 of FIG. 1 and features having a same name may operate the same or similarly. For example, both systems 100, 200 include a client 110, 210 and a server 120, 220; where the clients 110, 210 may contact the servers 120, 220 to obtain access and usage rights to content for which actions may be performed using the document viewers 140, 240. In addition to the features of the system 100 of FIG. 1, the system 200 includes a credential server 205, a relationship repository 225, a secure document generation server 215, information repository 235, and log repository 250.

In general, in the system 200, information from the information repository 235 may be secured as a secure document such that the client 210 may only perform actions with the content of the secure document (e.g., a component of a secure document or an entire secure document) after obtaining authorization from the server 220, such as described in U.S. Provisional Patent Application entitled “Trusted Third Party Authorization”, filed Apr. 11, 2006, Application Serial No. 60/791,289, the entire contents of which are hereby fully incorporated by reference. From the generation of a secure content to its viewing, the sequence may be as follows. Information from the information repository 235 may be packaged and secured in a document by the secure document generation server 215 in accordance with a specification for organizing the content and a policy of maintaining security (e.g., terms and conditions). A policy or policies for organizing the content and maintaining security may be determined by preferences of a data content owner or data content subject as identified by a query of the credential server 205 (e.g., based on preferences associated with a relationship of a data content subject and data content recipient).

Although the information repository 235 appears paired with the secure document generation server 215 that need not be the case. For example, the information repository 235 may reside on one or more servers remote from the secure document generation server 215. Also, the secure document generation server 215 need not contact the information repository 235 directly to receive information. For example, a component may act as a data broker, and the data broker may include a tool that facilitates synchronous or asynchronous ETML (Extraction, Transformation, Move, and Load of data e.g., data need not be available when requested); or data-level, process-level, or service-level integration between the secure document generation server 215 and the information repository 235 where the data broker allows for aggregation and integration of content remote from the secure document generation server 215.

The client 210 may request content from a website 270, which requests content from the secure document generation server 215. The client 210 may be authorized for downloading of content by the website 270, which receives secure documents or components of secure documents from the secure document generation server 215. In some implementations, the secure document generation server 215 need not publish back to the website 270. For example, secure documents or components of secure documents may be sent to a user in an electronic mail message, published to the repository 230 of secure documents (which, for example, may be shared by multiple clients), and the like. In some implementations, a user need not use the client 210 to request content from the website 270 (e.g., the requesting of content and its viewing need not be combined features of the client 210).

As an example of the client 210 requesting content, the website 270 may receive credentials, such as a user name and password, from the client 210. As another example, a user may request content directly from the website 270. In either case, if the user is authenticated and authorized, the content may be downloaded. Following the examples, the website 270 may contact the secure document generation server 215 for content. Then, the secure document generation server 215 may contact the credential server 205 to determine a policy of usage of the content (e.g., terms and conditions to be packaged with the content) and policy of generating the data (e.g., specification of a format for the data; e.g., a layout or specification of filtering of data).

The content that is requested by a potential data content recipient need not have a one to one cardinality between a data content subject and a data content recipient. For example, content may be requested for a number of data content subjects by a data content recipient. In some cases, content related to multiple data content subjects may be necessarily or, for convenience, packaged in a single secure document. For example, panel data that may be distributed in the interest of public health may be requested and that panel data may be based on multiple data content subjects. To accommodate for multiple secure content subjects, the secure document generation server 215 may be able to generate a secure document with components that respect terms and conditions of use associated with each of the multiple data content subjects mentioned therein (e.g., a variety of policies may specify different terms and conditions for different data content subjects, and terms and conditions of those policies may be embedded in a secure document and adhered to by the client 210).

Policies for generating secure documents may depend on a data content recipient (e.g., for a recipient of a certain insurance company in Massachusetts, insurance companies in Massachusetts may have certain requirements different from other states or that company may have preferences that differ from other companies), relationship of data content subject and data content recipient, and the like. The secure document generation server 215 may package the requested content in accordance with policies provided by the credential server 205. Then, the user of client 210 may download the content as part of a secure document. In some implementations, access for downloading of content may be restricted and the secure document generation server 215 may contact the credential server 205 to determine whether content may be downloaded by an authenticated user or accessed by the an authenticated user using client 210.

To view or otherwise access the content, the client 210 may request access from the server 220 by sending the secure content and credentials for the user. Then, the server 220 may determine the user of client 210 is authorized based on the presented credentials, the server 220 may determine whether the client 210 is an authorized mechanism by which the authorized user is able to access the content (e.g., both of which may be occur with assistance of the credential server 205), and, the server 220 may decrypt the content and send the content to the client 210. To send the content to the client 210, the server 220 may secure the content in accordance with a session key negotiated with the client 210 or using other techniques or mechanisms that enable the client 210 to access the content. In implementations involving different types of access and usage rights, the server 220 may receive an indication of a type of access or usage requested and the server 220 may approve or deny a specific action. Types of access and usage rights may depend on a user of the client 210 (e.g., different access and usage rights may be associated with different relationships of data content recipients and a data content subject), and the client 210 may enforce those access and usage rights and prevent unauthorized access. In some implementations, access and usage rights may be restricted based on terms and conditions of a secure document or component of secure document that are included in a secure document. Access and usage rights may also be restricted based on capabilities of the client 210 to provide security or reliably restrict access or use by the data content recipient. In addition, the terms and conditions may differ depending on a role of a data content recipient. For example, a system that accesses content as the client 210 may have a role as a research institution, and terms and conditions for usage of the content may be enforced based on that role (e.g., terms and conditions may differ across different roles). For users having multiple roles, different conflict resolution procedures may be adhered (e.g., a broadest or most restrictive set of terms and conditions may be adhered).

The packaging and securing of content by the secure document generation server 215 may occur in response to a request for content from the client 210 or in response to other stimulus. For example, in a medical environment, a doctor may request results of an exam and that information may be packaged in a particular format and secured at the secure document generation server 215. Documents may be encrypted using a cryptographic public key that corresponds to a cryptographic private key that is necessary for decryption at the server 220. In some implementations, any number or types of security may be applied at the secure document generation server 215. Different types of security may have different strengths (e.g., one cryptographic algorithm strength may be inherently stronger than another, or alternatively the same cryptographic algorithm may be made stronger by altering the keys or other inputs to the algorithm used). The format for generating a secure document may be the format described with reference to FIG. 3 and preferences of the format of content of the holdings may be determined with reference to policies provided by the credential server 205. In some implementations, a number of formats may be supported (e.g., for different systems that use different formats). Many different types of computer-based resources, or content, may be in the information repository 235. For example, in a health care environment, the information may include insurance claims, bills, x-rays, test results, signed waivers, doctor observations, a medical history summary, and the like.

Any number of secure document generation servers, such as the secure document generation server 215 may be deployed for distributed secure data generation. For example, in a health care environment, a number of secure document generation servers may be distributed across different insurance companies and hospitals for generating secure versions of their respective information.

To deal with updates to data, changes may be required to be performed at a source, such that a secure document generation server, such as the secure document generation server 215, packages and secures updated content. Once changes have been made, access to secure documents in circulation may be disabled (e.g., a request of the server 220 to view a secure document or component of the secure document may be denied) and parties seeking access to changed content may be notified that updates may be retrieved. In some implementations, status or awareness of updates may be published. For example, the secure document generation server 215 may publish updates to the client 220 or the website 270.

In general, the credential server 205 manages polices for access and usage of content that may be stored in a secure document such as the structure 300 of FIG. 3, including specifications or policies of packaging of information in secure documents and usage of secure documents. In addition, the credential server 205 may manage authentication and authorization of users (e.g., users of the website 270 or users who make requests for usage through the server 220 may be authenticated by the credential server 205 using combinations of security information managed by the credential server 205; e.g., the credential server 205 may issue credentials to the client 220). For example, the credential server 205 may provide for specification of preferences (e.g., preferences for terms and conditions of a secure document) and relationships (e.g., relationships among users and users, organizations and users, organizations and users, and organizations and organizations), in addition to generation, distribution, and revocation of policies (e.g., policies for generation of a secure document or terms and conditions of a secure document) and digital credentials. For example, the secure document generation server 215 may retrieve necessary key information from the credential server 205 to package a secure document that may take the form of a secure electronic health record, according to a specification that has been predefined with an insurance company for that specific insurance group. For example, different states or different companies may have different requirements for providing access or use of content to data content recipients, necessitating that generation of secure documents to be used as secure electronic health records may need to differ depending on a location of a data content subject's primary residence or the place where a data content recipient (e.g., a physician) is providing care such that content of a secure electronic health record is required. For example, policy preferences, such as a duration or location of access, may be part of terms and conditions of usage of content that are provided by the credential server 205.

The credential server 205 may use a relationship repository 225 to store relationships of individuals and organizations, and information about those individuals, organizations, and relationships. For example, a relationship between an insured party and an insurance company may be stored with preferences for access and usage of patient information of the insured party by the insurance company. For example, a relationship between a patient and a research institution may indicate that the research institution may view some types of medical information but not others (e.g., some types of secure holdings but not others). The relationship repository 225 may be implemented as a hierarchical or relational directory, identity management repository, or custom repository or product where individual and organization references are associated with credentials for access to resources and other attributes.

Attributes may include types of access and usage rights for a relationship (e.g., view, print, copy, modify, and the like), access and usage conditions (e.g., restricting viewing by Internet Protocol address, a geography defined by an Internet Protocol address, a time period (e.g., authorization may be valid for ninety days), and the like), types of authorized information (e.g., in a health care environment claims information may be authorized for view by an insurance company but not a research institution), roles (e.g., in a health care environment, a data content recipient having a doctor role may have different access and usage rights than a data content recipient being a hospital administrator), or some combination of the above or other attributes.

To determine whether access and usage rights are allowed for a relationship, information about a component of a secure document (e.g., information about a secure holding) may be used to classify the component such that it may be compared against attributes (e.g., metadata of a secure holding may indicate the holding includes claims information and an attribute of a relationship may indicate access and usage of the claims information is allowed).

In alternative implementations, access and usage rights need not be based on relationships between parties. For example, data content recipients may be associated with content that has access and usage rights attributes. In general, preferences for access of information may be based on a component level (e.g., in the structure 300 of FIG. 3, on the granularity of a secure holding, such as a classification of secure holdings).

In alternative implementations, access and usage rights need not be associated with relationships between parties, but may be implicit or explicit preferences of a party. For example, access and usage rights may be implicit or explicit preferences of a data content subject or data content custodian. For example, a data content subject may have a general preference of sharing health plan membership information with any inquiring doctor, independent of an explicit relationship with that doctor or knowledge or trust (e.g., a direct or indirect relationship) of any of the doctor's know affiliates (e.g., staff, partners, locations of practice, and the like).

In scenarios involving a denial of access by the credential server 205, the credential server 205 may process a request for authorization (e.g., from a data content subject or data content custodian). Such a request may be forwarded to a data content subject or data content custodian, such that authorization may be permitted by user interaction. For example, a text message stating that a doctor is requesting access to a certain type of medical data may request a response for authorization being yes or no. Additional policies may be generated in response to such a request or may be considered a one-time exception to typical authorization processing. For example, a new relationship may be generated at the relationship repository 225 and that relationship may include attributes authorizing the data content recipient.

The server 220 may maintain a log of events in the log repository 250. Different events may be logged. For example, the log may include an entry for each access, or attempted access, to a document by a client. Logged events may include varying granularities of detail. To ensure security of a log, the log may be encrypted, not include information that may easily be used to identify a person or company of which information is logged, or a combination of techniques and mechanisms may be implemented.

A log may be used to monitor access to and use of secure documents, parts of secure documents, or components of those parts that may assist ensuring security. For example, a data content subject may review log access to content distributed in secure documents which may provide assurance that unauthorized users have not accessed that content. In a health care environment, some users may be required to monitor medical information and a log may be used as a compliance verification tool to determine if someone is monitoring information. Logging may include both accesses that are approved and denied. In some implementations, logging of approvals may include limited information whereas denials may include detailed information (e.g., to assist in showing a policy prevented access to information). For example, an entry of an approval may include metadata about content approved and a data content recipient, whereas a denial may further include a description of a policy of a user (e.g., a policy of a relationship of a data content subject and data content recipient) that led to a denial. The log may be viewed by, as examples, a user of the website 270 (e.g., to data content subjects, data content recipients, data content custodians, and the like) or a system administrator of the server 220. Authorization to view the log may be provided based on attributes associated relationships in the relationship repository 225 (e.g., and governed by the credential server 205).

Contents or changes of a log may be distributed, or accessed as part of a secure or otherwise distributed communication to authorized parties that may have interest or requirements to observe the log and its changes. For example, a log may be distributed across different portions of one or more computer systems. As another example, updates about access to a patient's medical history may be communicated to the patient in the form of a secure document, an electronic mail notification, a text message, and the like. Similarly, for example, access to a patient's treatment eligibility or coverage information may be communicated to that patient's insurance company or payer, such that the organization may be notified of potential opportunity for investigating an incident that may be of interest.

Although the system 200 of FIG. 2 includes a certain number and type of components, implementations may differ. For example, a number of clients, secure document generation servers, and servers may exist.

As another example, an interface for providing access or usage of data to a user need not be a website, such as the website 270 and the interface of the client 210 may differ. For example, a suite of web-accessible services, such as services that might be accessed via SMS (Short Message Service), MMS (Multimedia Messaging Service), or IVR (Interactive Voice Response) system may be provided. The services may be exposed by an underlying application programming interface that may communicate with the secure document generation server 215, the credential server 205, and the server 220. The client 210, as examples, may be a mobile phone that accepts and composes text messages, a telephone, personal data assistant, and the like.

As another example, the hosting and granularity of features may differ. For example, the server 220, the website 270, and the credential server 250 may be hosted at a same site, different sites, or some combination of hosting may be performed. Similarly, the hosting of repositories need not be paired with servers and intermediate components may exist. For example, the relationship repository 225 need not be paired with the credential server 205 and a server may be used to interface with the relationship repository 225.

Although FIGS. 1 and 2 include a separation between a client 110, 210 and a server 120, 220, such a division need not exist. In general, the terms client and server may refer to client and server application programs, although, they may refer to client and server computer systems. A client and server are generally remote from each other and typically interact through a communication network; however, a client and server need not have a dedicated connection. The relationship of client and server may arise by virtue of one computer program, referred to as a server, providing a service to another computer program, referred to as a client. The servers 220, 120 may be referred to as a “clearing server,” and a combination of the credential server 205 and the server 220 may be referred to as a “policy server,” “identity management tool,” or “policy management tool.”

FIG. 3 is a diagram of a structure 300 for a secure document. The structure 300 may be referred to as a secure container and includes the secure holdings 310, metadata 320, and a rights management specification 330. The structure 300 may be a structure of the secure documents of the repositories 130, 230 of systems 100, 200 of FIGS. 1, 2. For example, each of the secure holdings 310 may be one of the secure documents of the repository 130 of FIG. 1. For example, in a health care environment the structure 300 may be a secure electronic health record of a data subject and each of the secure holdings 310 may be portions of a health record, such as a set of test results, an x-ray image, and the like.

The secure holdings 310 are components of the structure 300 and each of them may be secure from access. For example, each of the secure holdings 310 may be encrypted. Each of the secure holdings 310 may have separate types of security or require separate credentials; a uniform type of security may be applied to the secure holdings 310; or some commonality of security may exist. For example, in health care environment, claims may be secured using a same protocol for their secure holdings while a different security protocol may be used for secure holdings of medical results, such as x-rays. In some implementations, the secure holdings 310 may include information in addition to content. For example, terms and conditions of use of content of the secure holdings 310 may be encrypted with each of the secure holdings 310. For example, terms and conditions may include a specification requiring the use of a specific issuing root public key certificate that is trusted to facilitate clearing of the content. Each of the secure holdings 310 may further include a unique identifier that allows the secure holdings 310 to be tracked, along with the structure 300 that was used at the time the structure 300 was constructed.

The metadata 320 may include information about the structure 300 and the secure holdings. In particular, the metadata 320 may include an index of the secure holdings 310 in the structure 300 and a general description of the structure 300. For example, in a health care environment, the metadata 320 may include non-sensitive biographical information about a patient and short descriptions of secure holdings 310 that may be searched on the basis of non-sensitive diagnosis and procedure codes. For example, information identifying a data content subject in one of the systems 100, 200 of FIGS. 1, 2 may be included without identifying an individual outside of the system (e.g., an identifier of a patient used in the systems 100, 200 but not related to a social security number), and that information may be used to identify the data content subject when determining whether a data content recipient is authorized to view secure holdings.

The rights management specification 330 may include a specification of data from a secure document generation server, such as the secure document generation server 215, that details security for the secure holdings 310. For example, in the health care environment, information about the building of a secure electronic health record may be included. In addition, information for a client to access the secure holdings may be included in the rights management specification 330. For example, information identifying a location of a server for providing authorization, which may be referred to as a clearing server, and a specification of roles and credentials that are eligible for requesting content access. The rights management specification 330 may be articulated in a declarative format (e.g., RFC 822 compliant file, eXtensible Markup Language dialect, runtime compiled scripting language, and the like) or programmatic format (e.g., application programming interface, and the like) used by a programmatic subsystem that encrypts data to generate a secure container.

Although the structure of FIG. 3 includes a certain number and type of features, additional, fewer, or different features may be included. For example, the rights management specification 330 may be combined with the metadata 320.

As another example, although FIG. 3 shows a first level of nesting of secure holdings 310 of the structure 300, there may be any number of levels of nesting of sub-components or sub-holdings. For example, a secure holding may have multiple secure sub-holdings. The secure sub-holdings themselves may be documents that are separately encrypted or an entire secure holding of a secure document may be encrypted. The security applied to sub-holdings may either be dependent or independent of the security applied to the secure holding of which it is apart. Similarly, different terms and conditions may be applied to different secure sub-holdings of the secure holding of a secure document. For example, in the generation of a secure document to reflect population-specific information, content for multiple data content subjects may be organized into individual sub-holdings of a parent secure holding that represents a specific classification of population information (e.g., diagnosis or disease identification information) while each secure sub-holding is independently governed by access and usage policies appropriate for each respective data content subject.

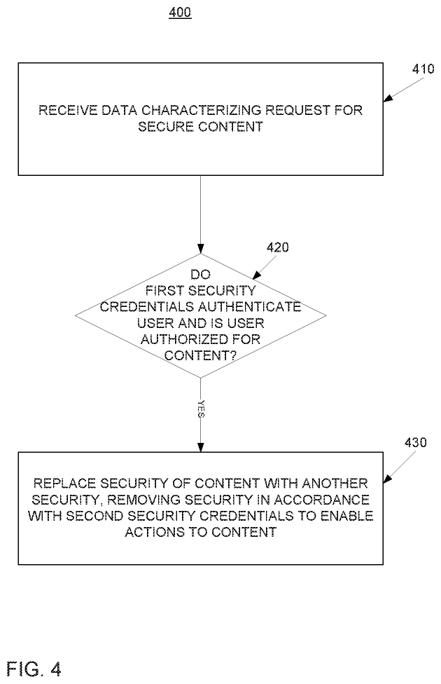

FIG. 4 is a flowchart illustrating a process 400 of dynamic binding of access and usage rights. The process 400 may be performed by the systems 100, 200 of FIGS. 1, 2, or another system. In general, the process involves replacing security of secured content based on credentials that are different from credentials that may be used to remove the security. Content may include secure holdings or portions of secure holdings of the structure 300 of FIG. 3.

Data characterizing a request for secure content is received (410). The request may be received at a server that services requests for authorizing access to content, such as the servers 120, 200 of FIGS. 1, 2. The request may have been generated by a client attempting to access secure content, such as the clients 110, 210 of FIGS. 1, 2. The data characterizing the request may be a message including the secure content and metadata for the secure content. For example, a secure holding of a medical record may be sent with an identifier of a data content subject. The request may be generated by a user of a client or as part of a program. For example, a request may be generated when a program attempts to access secure content as part of performing a task that uses the content. The request may further include one or more actions (e.g., types of actions) requested to be performed or authorized.

A determination is made as to whether first security credentials authenticate a user and the user is authorized (420). The determination may be made by the same component that receives the request for access to content (410; e.g., the server 120 of FIG. 1). The first security credentials may be sent as part of a login procedure for authenticating a user (e.g., a person or a program) that attempts to access secure content. For example, as part of starting a secure server session with the server 120 of FIG. 1, a user of the client 110 may enter a username and password to identify an account of the user. The first security credentials may be used to identify an account associated with the credentials to determine whether the user is authorized to access or use the content.

If the first security credentials authenticate a user and the user is authorized to use the content, the security of the content is replaced which includes removing the security of the content in accordance with second security credentials to enable actions to the content (430). Removing the security may involve determining whether a user or account associated with the first security credentials is authorized to access the content. In addition, the process may involve determining the types of access and usage rights allowed. For example, access right attributes may be associated with a relationship among any combination of users and organizations. In addition, the process may involve determining whether a client is trusted for access or usage of content.

For example, the first credentials may be used to identify an account of a data content recipient. Metadata of a secure document that is sent with a request to access the document may be used to determine an account of the data content subject. Then, a logical structure capturing relationships, such as a table of a database or configuration file, may be queried to determine if the data content subject and data content recipient have a direct or indirect relationship. If a relationship does not exist, the data content recipient might not be granted access. If a relationship does exist, the relationship may include access right preferences that may be used to determine access and usage rights to grant to a data content recipient (e.g., a user attempting to access content). Default preferences of a data content subject or the preferences of their relationships may also be used to determine outcomes for authorization. For example, a patient might not have an express relationship regarding the ability to provide access to treatment eligibility information, but a relationship between the patient's employer and the patient's current insurance company may have specified this setting for the patient's authorization of this information by default.

As part of replacing security, other types of security may be added. For example, the server 220 of FIG. 2 may decrypt a component of a document using a private key stored at the clearing center 205 and then encrypt the component of the document using a session key negotiated in a secure server session between the client 210 and the server 220. The purpose of having such a combination of removing security in lieu of other security may move a secure document from a first trusted environment to a second trusted environment. In addition, by preventing security of a transportable container from being removable at a client, security may be improved. For example, a client need not receive a key that may be used at any computer to decrypt an easily transportable version of the document, which may prevent exposure of security mechanisms; and, exposure of a session key of a single document that is expected to be in a second trusted environment for the length of a session might be considered a less significant security risk.

In addition to the process 400, the content may be transmitted to a data content recipient that requested access. In some implementations, rather than approving or denying a type of access, transmission of the data may also include a specification of rights to be adhered to by the requestor. For example, access right preferences, such as authorizing viewing and printing but not copying content may be sent to the client 110 and enforced by the client 110.

Although FIG. 4 has a certain combination of sub-processes in a certain order, additional, fewer, or different sub-processes may be used and the order may differ. For example, the determination of 420 may be made prior to receiving the request for access to content of 410.

Although FIGS. 1-4 are discussed with references to examples in a health care environment, similar techniques and mechanisms may be employed in other environments.

A user, as discussed with reference to FIGS. 1-4 generally refers to a person who manipulates an input device to interact with a computer; however, the term user need not be so limited. For example, a user may be a computer program that acts as a user. For example, the client 110 of FIG. 1 may be used by a program and such a client may include, for example, an application programming interface in lieu of a graphical user interface.

In an aspect, data characterizing a request for access and usage of a content by a user of a client can be received. The request can include a first security credential of the user and a first secure container. The first secure container can include a metadata, a rights management specification, and a first secure holding, the first secure holding including the content secured with a first security. The user can be authenticated using the first security credentials and the authenticated user can be authorized for access and usage of the content based on access and usage specified in a first terms and conditions. The first security of the content can be replaced with a second security of the content by decrypting the first security using a second security credential, negotiating a session key with the client, and securing the content with the second security. The content can be secured with the second security by re-encrypting the content using the negotiated session key. The negotiated session key can be independent of security applied by a communication protocol. A second secure container can be provided. The second secure container can include the metadata, the rights management specification, and the re-encrypted first content.

One or more of the following features can be included in any feasible combination. For example, the providing can further include transmitting, to the client, the second secure container using a secure server session. The second secure container can include access right preferences authorizing the client to perform actions specified in the terms and conditions. The client can enforce the access right preferences by preventing unauthorized access to the content in the second secure container. The request for access and usage of the content by the user can further include a description of actions desired to be performed by the user at the client. The actions desired to be performed by the user at the client can include viewing, printing, copying, modifying, and/or exporting. Access and usage of the first content by the user can be determined by a relationship between the client and a data content subject.

The first terms and conditions can be packaged with the content and can include duration of access, location of access, trusted issuing root public key certificate, and/or actions authorized to be performed. The metadata can include an index of the first secure holding, non-sensitive biographical information, short descriptions of the first secure holding including non-sensitive diagnosis and/or procedure codes, and/or a data content subject identifier. The rights management specification can include information identifying a clearing server, a specification of roles eligible for requesting access to the content, and/or a specification of credentials eligible for requesting access to the content.

The user can include at least one role. The at least one role can include a data content subject, a data content recipient, a data custodian, a data publisher, a relationship administrator, and/or a system administrator. Authorization of access and usage of the first content can be provided to the user depending the at least one role of the user. The request can be forwarded to a data content subject or a data content custodian. The data content subject or the data content custodian can permit authorization by user interaction. The content can include an electronic health record, an insurance claim, a bill, an x-ray, a test result, a signed waiver, a doctor observation, and/or a medical history summary.

In an aspect, data characterizing a request for content is received, a determination as to whether first security credentials authenticate a user is made, and, if so and the user is authorized to use the content, first security of the content is replaced with second security where replacing the first security includes removing the first security from the content in accordance with second security credentials. The replacing of security may enable the user to perform actions to the content.

In another aspect, data characterizing a request for content is received at a server from a client; a determination is made as to whether first security credentials authenticate a user of the client; and, if the user is authenticated by the first security credentials and authorized to use the content, a first security of the content is replaced with a second security, where the replacing includes removing the first security from the content in accordance with second security credentials and the user is authorized to perform at least one action associated with the user at the server.

The subject matter may be implemented as, for example, computer program products (e.g., as source code or compiled code), computer-implemented methods, and systems.

Variations may include one or more of the following features.

The actions may be performed in accordance with terms and conditions for content use. For example, terms and conditions in the content specified by a data content custodian, data content subject, or the like.

The user may be a person or a program.

Receiving data may be performed by a server application receiving the data from a client application performing the request, and the server application may perform replacing the security to move the content from a first trusted environment to a second trusted environment, where the second trusted environment includes a secure server session between the server and client applications.

Actions may include one or more types of actions authorized to be performed at a client of the user.

The content may be secured against access in accordance with a decryption scheme. Removing the first security may include decrypting the content with the second security credentials not being available to the user. Transmission of the content to the user may be initiated in accordance with a secure server session.

A determination may be made as to whether a user is authorized to perform the actions and the actions may only be performed if the user is authorized. The determination may include determining whether a relationship exists with another user with whom a relationship indicates that authorization is to be provided. The relationship may be explicit or implicit. An existence of a relationship or attributes associated with a relationship may indicate whether authorization is to be provided. A user may be authorized without regard to a relationship. For example, a user may be authorized based on a combination of a role of the user and a data content subject, and associated preferences. As another example, authorization may be based on a set of roles and rules. For example, a doctor may be authorized based on the doctor having a doctor role and a rule declaring that authorization be granted in an emergency healthcare setting. Authorization may be granted based on whether a user has access rights, usage rights, usage right conditions, or a combination of those rights. For example, a user may have rights to view and print clinical test results on a hospital computer, but not other computers, associated with a relationship. Usage rights and conditions for usage may be considered a subset of access rights.

A determination may be made as to whether the user is associated with rights to perform the access or use the content, and replacing the first security may include replacing the security if the user has the rights to perform the access.

The user may have rights to perform the access or use at a first time but not have the rights to perform the access or use at a second time later or earlier than the first time based on a modification of a policy of the user (e.g., preferences of usage rights of a relationship between a data content subject and data content recipient may be changed). For example, content may be issued such that access is granted and a user downloads secure content. And, at a later time, a data content subject may desire to revoke permission and the user is unable to use the content (e.g., denied viewing rights when requesting usage of the content).

Access of the content may be limited to a number of accesses or uses (e.g., a limit of printing five times).

The content may be medical health information, such as a secure electronic health record.

The content may be a component of an electronic medical record including multiple components, where the user is authorized for the content but not authorized for at least one other component.

The actions may include one or more of causing the content to be viewed, printed, copied, modified, or exported (e.g., removed from a security container).

The user may be authorized for at least one type of action but not other types of actions.

The user may be authorized for a set of actions different from actions authorized for another user.

The subject matter described herein can be implemented to realize one or more of the following advantages. Access and usage rights to secure content may be dynamically bound such that access and usage rights may change independent of security of content. Access and usage rights may be considered dynamically bound as, for example, the rights need not be included with secured content and may be bound at a later time. For example, a client may need to request access and use of a secure document from a server, where access and usage rights may be changed from time to time. For example, access to secure content may be disabled even after it has been received by an intended recipient. Documents may be secured such that security may only be removed by a server remote from clients and continuous data protection may be provided to documents. Access logging may be performed at the server that grants access and usage rights, which may take advantage of the server's role in receiving requests for access and usage rights from a variety of sources and a requirement to use a server to request access and usage rights, such that the logging may be accurate. Documents may be transportable and security may be maintained. For example, documents may be stored in a secure structure. By having a distributed architecture of secure content that is transportable, additional costs need not be incurred for storage of data in a centralized repository, for data to be specifically secured for each identified data content recipient, or for specific use of secure content that a data content recipient may require. In addition, in the health care environment such decentralized data ownership may assist in removing potential risk associated with storage of vast amounts of patient information.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other in a logical sense and typically interact through a communication network. The relationship of client and server arises by virtue of computer programs running on the respective computers and having a client-server relationship to each other.

The subject matter described herein has been described in terms of particular embodiments, but other embodiments can be implemented and are within the scope of the following claims. For example, operations can differ and still achieve desirable results. In certain implementations, multitasking and parallel processing may be preferable. Other embodiments are within the scope of the following claims

What is claimed is:

1. A method comprising:
receiving data characterizing a request for access and usage of a content by a user of a client, the request including a first security credential of the user and a first secure container, the first secure container including a metadata, a rights management specification, and a first secure holding, the first secure holding including the content secured with a first security;
authenticating the user using the first security credentials and authorizing the authenticated user for access and usage of the content based on access and usage specified in a first terms and conditions;
replacing the first security of the content with a second security of the content by decrypting the first security using a second security credential, negotiating a session key with the client, and securing the content with the second security, the content secured with the second security by re-encrypting the content using the negotiated session key, the negotiated session key being independent of security applied by a communication protocol; and
providing a second secure container, the second secure container including the metadata, the rights management specification, and the re-encrypted first content.

2. The method of claim 1, wherein the providing further comprises:
transmitting, to the client, the second secure container using a secure server session;
wherein the second secure container includes access right preferences authorizing the client to perform actions specified in the terms and conditions; and
wherein the client enforces the access right preferences by preventing unauthorized access to the content in the second secure container.

3. The method of claim 1, wherein the request for access and usage of the content by the user further includes a description of actions desired to be performed by the user at the client, the actions desired to be performed by the user at the client including viewing, printing, copying, modifying, and/or exporting.

4. The method of claim 1, wherein access and usage of the first content by the user is determined by a relationship between the client and a data content subject.

5. The method of claim 1, wherein the first terms and conditions are packaged with the content and include duration of access, location of access, trusted issuing root public key certificate, and/or actions authorized to be performed.

6. The method of claim 1, wherein the metadata includes an index of the first secure holding, non-sensitive biographical information, short descriptions of the first secure holding including non-sensitive diagnosis and/or procedure codes, and/or a data content subject identifier.

7. The method of claim 1, wherein the rights management specification includes information identifying a clearing server, a specification of roles eligible for requesting access to the content, and/or a specification of credentials eligible for requesting access to the content.

8. The method of claim 1, wherein the user includes at least one role, the at least one role including a data content subject, a data content recipient, a data custodian, a data publisher, a relationship administrator, and/or a system administrator.

9. The method of claim 8, wherein authorization of access and usage of the first content is provided to the user depending the at least one role of the user.

10. The method of claim 1, wherein the request is forwarded to a data content subject or a data content custodian; and
wherein the data content subject or the data content custodian permits authorization by user interaction.

11. The method of claim 1, wherein the content includes an electronic health record, an insurance claim, a bill, an x-ray, a test result, a signed waiver, a doctor observation, and/or a medical history summary.

12. A system comprising: at least one data processor; and memory storing instructions which, when executed by the at least one processor, causes the at least one processor to perform operations comprising:
receiving data characterizing a request for access and usage of a content by a user of a client, the request including a first security credential of the user and a first secure container, the first secure container including a metadata, a rights management specification, and a first secure holding, the first secure holding including the content secured with a first security;
authenticating the user using the first security credentials and authorizing the authenticated user for access and usage of the content based on access and usage specified in a first terms and conditions;
replacing the first security of the content with a second security of the content by decrypting the first security using a second security credential, negotiating a session key with the client, and securing the content with the second security, the content secured with the second security by re-encrypting the content using the negotiated session key, the negotiated session key being independent of security applied by a communication protocol; and
providing a second secure container, the second secure container including the metadata, the rights management specification, and the re-encrypted first content.

13. The system of claim 12, wherein the providing further comprises:
transmitting, to the client, the second secure container using a secure server session;
wherein the second secure container includes access right preferences authorizing the client to perform actions specified in the terms and conditions; and
wherein the client enforces the access right preferences by preventing unauthorized access to the content in the second secure container.

14. The system of claim 12, wherein the request for access and usage of the content by the user further includes a description of actions desired to be performed by the user at the client, the actions desired to be performed by the user at the client including viewing, printing, copying, modifying, and/or exporting.

15. The system of claim 12, wherein access and usage of the first content by the user is determined by a relationship between the client and a data content subject.

16. The system of claim 12, wherein the first terms and conditions are packaged with the content and include duration of access, location of access, trusted issuing root public key certificate, and/or actions authorized to be performed.

17. The system of claim 12, wherein the metadata includes an index of the first secure holding, non-sensitive biographical information, short descriptions of the first secure holding including non-sensitive diagnosis and/or procedure codes, and/or a data content subject identifier.

18. A non-transitory computer program product storing instructions, which, when executed by at least one data processor of at least one computing system, implement operations comprising:
receiving data characterizing a request for access and usage of a content by a user of a client, the request including a first security credential of the user and a first secure container, the first secure container including a metadata, a rights management specification, and a first secure holding, the first secure holding including the content secured with a first security;
authenticating the user using the first security credentials and authorizing the authenticated user for access and usage of the content based on access and usage specified in a first terms and conditions;
replacing the first security of the content with a second security of the content by decrypting the first security using a second security credential, negotiating a session key with the client, and securing the content with the second security, the content secured with the second security by re-encrypting the content using the negotiated session key, the negotiated session key being independent of security applied by a communication protocol; and
providing a second secure container, the second secure container including the metadata, the rights management specification, and the re-encrypted first content.

19. The non-transitory computer program product of claim 18, wherein the providing further comprises:
transmitting, to the client, the second secure container using a secure server session;
wherein the second secure container includes access right preferences authorizing the client to perform actions specified in the terms and conditions; and
wherein the client enforces the access right preferences by preventing unauthorized access to the content in the second secure container.

20. The non-transitory computer program product of claim 18, wherein the request for access and usage of the content by the user further includes a description of actions desired to be performed by the user at the client, the actions desired to be performed by the user at the client including viewing, printing, copying, modifying, and/or exporting.
